(19) United States
(12) Patent Application Publication
(10) Pub. No.: US 2024/0034302 A1
(43) Pub. Date: Feb. 1, 2024

(54) SYSTEMS AND METHODS FOR PREDICTIVE CONTROL AT HANDLING LIMITS WITH AN AUTOMATED VEHICLE

(71) Applicant: Toyota Research Institute, Inc., Los Altos, CA (US)

(72) Inventors: James Andrew Dallas, Mountain View, CA (US); Michael Thompson, San Juan Capistrano, CA (US); Yan Ming Jonathan Goh, Palo Alto, CA (US); Avinash Balachandran, Sunnyvale, CA (US)

(73) Assignees: Toyota Research Institute, Inc., Los Altos, CA (US); Toyota Jidosha Kabushiki Kaisha, Toyota-shi (JP)

(21) Appl. No.: 17/949,450

(22) Filed: Sep. 21, 2022

Related U.S. Application Data
(60) Provisional application No. 63/393,007, filed on Jul. 28, 2022.
(60) Provisional application No. 63/392,942, filed on Jul. 28, 2022.

(51) Int. Cl. B60W 30/02; B60W 30/18; B60W 40/068; B60W 50/00; B60W 10/06; B60W 10/184

(52) U.S. Cl. CPC B60W 30/02; B60W 30/18172; B60W 40/068; B60W 50/0097; B60W 10/06; B60W 10/184; B60W 2520/20; B60W 2510/18; B60W 2050/0052; B60W 2710/18; B60W 2710/06; B60W 2510/1005

(57) ABSTRACT

System, methods, and other embodiments described herein relate to adjusting a prediction model for control at handling limits associated with a projected trajectory during automated driving. In one embodiment, a method includes adjusting parameters of a prediction model using friction estimates and sideslip costs associated with a projected trajectory of a vehicle, the friction estimates being derived from Kalman filtering. The method also includes scaling, using the prediction model, handling limits of the vehicle for the projected trajectory according to a friction circle. The method also includes generating, by the prediction model, vehicle dynamics using a load transfer and a brake distribution, the vehicle dynamics being associated with estimated road conditions and the handling limits. The method also includes outputting, by the prediction model using the vehicle dynamics, a driving command to the vehicle for the projected trajectory.

### CROSS-REFERENCE TO RELATED APPLICATIONS

This application claims the benefit of U.S. Provisional Application No. 63/393,007, filed on Jul. 28, 2022, and U.S. Provisional Application No. 63/392,942, filed on Jul. 28, 2022, which are herein incorporated by reference in its entirety.

### TECHNICAL FIELD

The subject matter described herein relates, in general, to predictive control for a vehicle, and, more particularly, to adjusting a prediction model for control at handling limits associated with a projected trajectory during automated driving.

### BACKGROUND

A vehicle has systems that control throttling, braking, and wheel angles. These systems determine maneuvers on the road using manual inputs or outputs from an automated driving system (ADS). For example, the ADS generates projected trajectories for the vehicle to execute and follow. Execution may impact safety and stability from physical forces (e.g., tire force) on the vehicle by a maneuver. A prediction model may generate driving commands for a projected trajectory using physical constraints. However, executed outputs from the prediction model can violate physical constraints and handling limits in certain environments, causing the vehicle to spinout and collide with objects on the road.

Moreover, systems can calculate and reduce costs (e.g., comfort, reliability, stability, etc.) for projected trajectories to prevent collisions. For example, the prediction model encodes vehicle dynamics, physical constraints, road topology, and costs for a projected trajectory to increase safety by reducing approximation errors. However, the encoding by the prediction model increases complexity and computational costs, particularly for non-linear control during extreme conditions. Furthermore, the vehicle performing online encoding can cause delays that increase collision probabilities, especially in scenarios involving sudden danger because of short reaction times or stopping distances. Therefore, a vehicle navigating a road with an ADS and factoring costs for projected trajectories can encounter difficulties, especially when encountering atypical driving scenarios.

### SUMMARY

In one embodiment, example systems and methods relate to adjusting a prediction model for controlling a vehicle at handling limits. In various implementations, systems using a prediction model to generate commands for a projected trajectory encounter decreased safety and stability during certain scenarios (e.g., a sharp curve). As one example, a prediction model generates a braking command that causes tire saturation by using a static distribution of available forces and load constraints. Therefore, in one embodiment, a prediction system adjusts a prediction model by implementing Kalman filtering that estimates friction involving a projected trajectory from an automated driving system (ADS). Here, the prediction model may implement a non-linear model predictive controller (NMPC) using dynamic load transfer and brake distributions and generate vehicle dynamics with the ADS at handling limits. The prediction model optimizes tire-force utilization (e.g., saturation) through the load transfer and brake distribution according to estimated road conditions. For example, the load transfer biases braking the front tires as load transfers forward during deceleration, thereby staying within the handling limits while using available road friction that improves traction.

Moreover, in various implementations, the prediction model improves performance at the handling limits by optimizing computations in a processing layer separate from chassis control. For example, the prediction model estimates wheel speed and dynamic allocation of brake torques from load transfer associated with cornering using an upper-level NMPC. In this way, the prediction model exploits additional dynamics and traction potential available by reducing tire-force deviation. As such, this improves comfort and reduces tire saturation or uncontrolled steering during automated driving. Furthermore, in one approach, the prediction model uses longitudinal load dynamics and a lateral-weight transfer in a steady-state, thereby rapidly accounting for evolving force potential at different tires. In this way, the prediction model optimizes the allocation of brake torque at different wheels. For instance, an Unscented Kalman filter (UKF) estimates friction and a cost for an allowable friction circle that accounts for estimated uncertainty. Here, the prediction model can adjust parameters using the estimated coefficient of friction for uncertainties online. Accordingly, the prediction model adjusts for control at handling limits associated with the projected trajectory that utilizes available traction potential and tire friction, thereby improving safety and comfort through increased control.

In one embodiment, a prediction system that adjusts a prediction model for control at handling limits associated with a projected trajectory during automated driving is disclosed. The prediction system includes a processor and a memory storing instructions that, when executed by the processor, cause the processor to adjust parameters of a prediction model using friction estimates and sideslip costs associated with a projected trajectory of a vehicle, the friction estimates being derived from Kalman filtering. The instructions also include instructions to scale, using the prediction model, handling limits of the vehicle for the projected trajectory according to a friction circle. The instructions also include instructions to generate, by the prediction model, vehicle dynamics using a load transfer and a brake distribution, the vehicle dynamics being associated with estimated road conditions and the handling limits. The instructions also include instructions to output, by the prediction model using the vehicle dynamics, a driving command to the vehicle for the projected trajectory.

In one embodiment, a non-transitory computer-readable medium that adjusts a prediction model for control at handling limits associated with a projected trajectory during automated driving and including instructions that when executed by a processor cause the processor to perform one or more functions is disclosed. The instructions include instructions to adjust parameters of a prediction model using friction estimates and sideslip costs associated with a projected trajectory of a vehicle, the friction estimates being derived from Kalman filtering. The instructions also include instructions to scale, using the prediction model, handling limits of the vehicle for the projected trajectory according to a friction circle. The instructions also include instructions to generate, by the prediction model, vehicle dynamics using a load transfer and a brake distribution, the vehicle dynamics being associated with estimated road conditions and the handling limits. The instructions also include instructions to output, by the prediction model using the vehicle dynamics, a driving command to the vehicle for the projected trajectory.

In one embodiment, a method for adjusting a prediction model for control at handling limits associated with a projected trajectory during automated driving is disclosed. In one embodiment, the method includes adjusting parameters of a prediction model using friction estimates and sideslip costs associated with a projected trajectory of a vehicle, the friction estimates being derived from Kalman filtering. The method also includes scaling, using the prediction model, handling limits of the vehicle for the projected trajectory according to a friction circle. The method also includes generating, by the prediction model, vehicle dynamics using a load transfer and a brake distribution, the vehicle dynamics being associated with estimated road conditions and the handling limits. The method also includes outputting, by the prediction model using the vehicle dynamics, a driving command to the vehicle for the projected trajectory.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a prediction system that is associated with adjusting a prediction model for controlling a vehicle at handling limits.

FIG. 3 illustrates one embodiment of the prediction system using a friction circle and scaling to adapt control at handling limits using the prediction model.

FIG. 4 illustrates one embodiment of a method that is associated with adjusting the prediction model for controlling the vehicle at the handling limits using Kalman filtering and scaling.

### DETAILED DESCRIPTION

Systems, methods, and other embodiments associated with adjusting a prediction model for controlling a vehicle at handling limits are disclosed herein. In various implementations, driving commands generated from a prediction model for a projected trajectory encounter decreased safety and traction loss during certain scenarios. For example, systems using a model predictive controller (MPC) generate riskier commands in certain circumstances, such as when an automated driving system (ADS) invokes a lane change at a curve. Here, the system may automatically generate a braking command from the MPC that causes tire saturation leading to a collision with objects (e.g., other vehicles, an animal, etc.) from control loss. Therefore, in one embodiment, a prediction system adjusts a prediction model by implementing Kalman filtering for friction estimates associated with a projected trajectory generated by the ADS. In particular, the adjustments may increase force utilization at handling limits. For example, the handling limits define force saturation and available friction for individual tires of a vehicle. In one approach, the Kalman filtering iteratively uses covariance in process and measurement noise, measurements of various states (e.g., a yaw rate, a velocity, etc.), and prediction errors to estimate friction accurately. The prediction system may also calculate and reduce various dynamic costs for increasing stability and comfort when following the projected trajectory.

In various implementations, the prediction system scales handling limits using the prediction model (e.g., a non-linear MPC (NMPC)) for the projected trajectory. Here, the prediction system can adapt a friction circle for the projected trajectory, such as at a track edge, near an obstacle, and so on, to avoid a collision. For example, the friction circle scales through expansion that increases force availability at individual tires within the handling limits, thereby preventing collisions. Furthermore, the prediction system generates vehicle dynamics using a load transfer and brake distribution model according to estimated road conditions and the handling limits. The prediction system may compute first-order dynamics for longitudinal load transfer such that available frictional forces at the handling limits are utilized for braking. For instance, the load transfer biases braking the front tires as load transfers forward during deceleration, such as at the handling limits. Thus, the prediction model adjusts control at the handling limits while utilizing available traction potential, tire friction, and tire forces that improve safety while reducing traction loss.

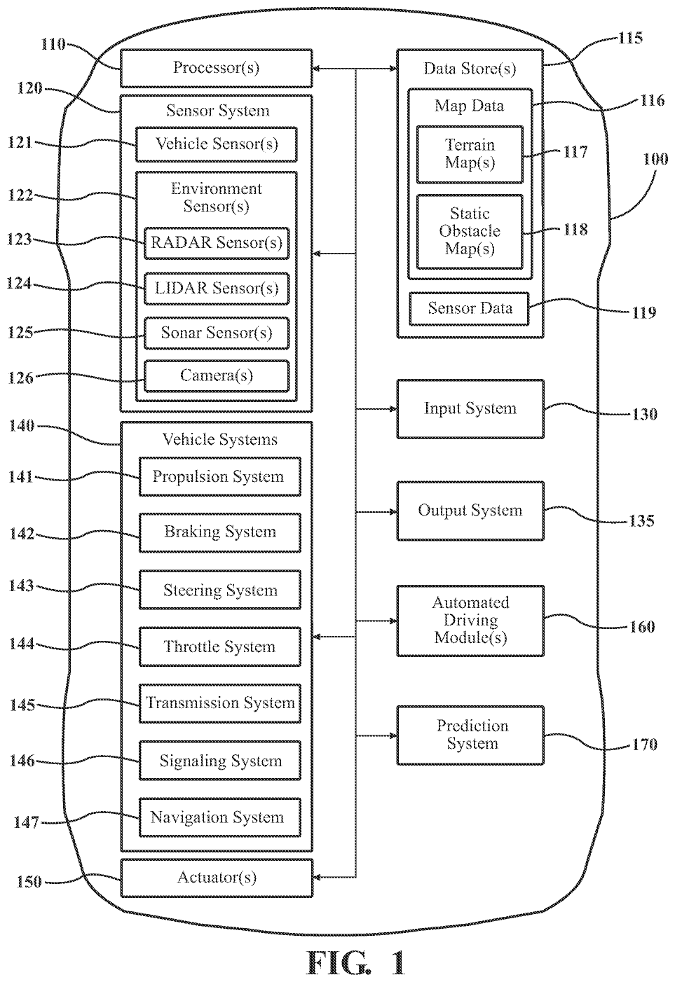

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a prediction system 170 uses road-side units (RSU), consumer electronics (CE), mobile devices, robots, drones, and so on that benefit from the functionality discussed herein associated with adjusting a prediction model for controlling a vehicle at handling limits.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances.

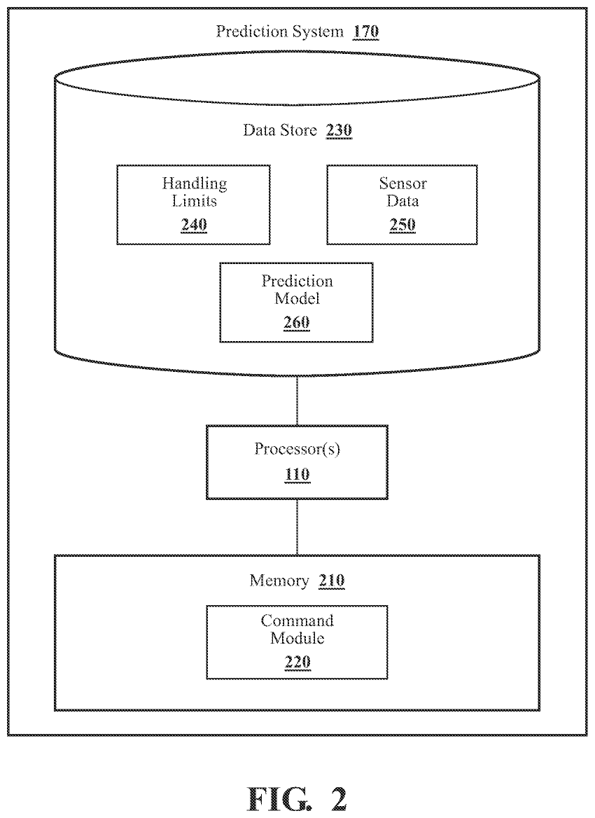

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a prediction system 170 that is implemented to perform methods and other functions as disclosed herein relating to improving the adjustment of a prediction model for controlling a vehicle at handling limits.

With reference to FIG. 2, one embodiment of the prediction system 170 of FIG. 1 is further illustrated. The prediction system 170 is shown as including a processor(s) 110 from the vehicle 100 of FIG. 1. Accordingly, the processor(s) 110 may be a part of the prediction system 170, the prediction system 170 may include a separate processor from the processor(s) 110 of the vehicle 100, or the prediction system 170 may access the processor(s) 110 through a data bus or another communication path. In one embodiment, the prediction system 170 includes a memory 210 that stores a command module 220. The memory 210 is a random-access memory (RAM), a read-only memory (ROM), a hard-disk drive, a flash memory, or other suitable memory for storing the command module 220. The command module 220 is, for example, computer-readable instructions that when executed by the processor(s) 110 cause the processor(s) 110 to perform the various functions disclosed herein.

Furthermore, the command module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the command module 220, in one embodiment, acquires the sensor data 250 that includes at least camera images. In further arrangements, the command module 220 acquires the sensor data 250 from further sensors such as the radar sensors 123, LIDAR sensors 124, and other sensors as may be suitable for identifying vehicles and locations of the vehicles.

Accordingly, the command module 220, in one embodiment, controls the respective sensors to provide the data inputs in the form of the sensor data 250. Additionally, while the command module 220 is discussed as controlling the various sensors to provide the sensor data 250, in one or more embodiments, the command module 220 can employ other techniques to acquire the sensor data 250, such as data fusing, that are either active or passive. Thus, the sensor data 250, in one embodiment, represents a combination of perceptions acquired from multiple sensors.

Moreover, in one embodiment, the prediction system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the command module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes the handling limits 240. For example, the handling limits 240 define force saturation and available friction for individual tires of the vehicle 100. As such, a spinout, traction loss, and so on may occur if the vehicle 100 exceeds the handling limits 240.

The command module 220, in one embodiment, is further configured to perform additional tasks beyond controlling the respective sensors to acquire and provide the sensor data 250. For example, the command module 220 includes instructions that cause the processor 110 to implement an ADS that plans and controls at the handling limits 240 of the vehicle 100. In this way, the prediction system 170 extracts increased potential and available friction for braking, irrespective of road conditions. Also, operating at the handling limits 240 allows the vehicle 100 to avoid obstacles by increasing or maximizing traction during deceleration and decreasing stopping distances without saturating tires, thereby avoiding unsafe spinout or plowing.

As explained below, the prediction system 170 may optimize and extract control potential by executing the prediction model 260 in a processing layer separate from chassis control. Here, in one embodiment, the data store 230 includes the prediction model 260 that has computer-readable instructions. The computer-readable instructions when executed by the processor(s) 110 cause the processor(s) 110 to perform the various functions disclosed herein. As such, the prediction system 170 executes the prediction model 260 at a layer separate or above from the chassis control. In this way, the processing layer for the prediction model 260 improves the accuracy of load transfer calculations by factoring grade measurements (e.g., road topology), sudden environmental changes, gear-change modeling, and so on through separation from chassis controls. Furthermore, the prediction system 170 using a separate (e.g., higher-level) processing layer can prioritize different attributes (e.g., minimum time, smoothness, comfort, etc.) while incorporating the non-linear dynamics for the vehicle 100 and model fidelity. The prioritization can improve determining the limits of the vehicle 100 given by friction and force limits at individual tires while avoiding saturating tires, oversteering, understeering, and so on.

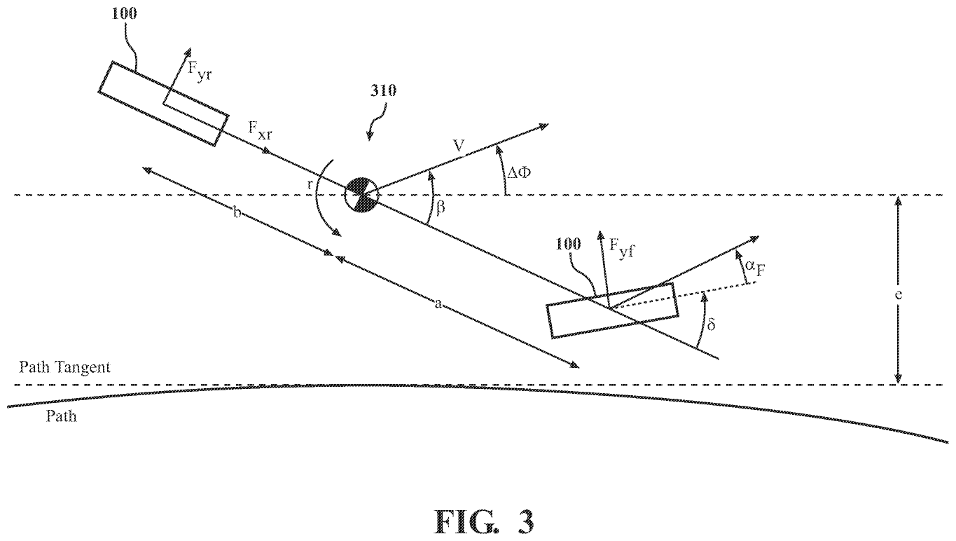

Now turning to FIG. 3, one embodiment of the prediction system 170 using a friction circle 310 and scaling to adapt control at the handling limits 240 using the prediction model 260 is illustrated. As explained below, the prediction system 170 can adapt the friction circle 310 for a projected maneuver by the vehicle 100 involving a track edge, obstacle, curve, and so on. The adaptation may include scaling through expanding the friction circle 310 for using available force, thereby preventing a collision. Here, the maximum force available is the tire friction multiplied by the normal load on the vehicle 100. Also, once a dangerous scenario is averted, the prediction system 170 may reduce the friction circle 310 which increases comfort by reducing sudden movements or jerks.

In various implementations, the prediction model 260 implements a NMPC using reference trajectories from a bicycle model for the vehicle 100 and a curvilinear coordinate system. Although certain examples implement an NMPC, the prediction system 170 may implement any MPC for adjusting a prediction model and controlling a vehicle at the handling limits 240. Here, the bicycle model may involve:

$$x = [ \begin{matrix}\begin{matrix}\begin{matrix}\begin{matrix}\begin{matrix}\begin{matrix}\begin{matrix}\begin{matrix}\begin{matrix}\begin{matrix}r \\ V\end{matrix} \\ B\end{matrix} \\ δ\end{matrix} \\ {ω}_{r}\end{matrix} \\ e\end{matrix} \\ Δ ϕ\end{matrix} \\ τ\end{matrix} \\ {τ}_{brake , f}\end{matrix} \\ {τ}_{brake , r}\end{matrix} \\ {dF}_{z}\end{matrix} ] = [ \begin{matrix}\begin{matrix}\begin{matrix}\begin{matrix}\begin{matrix}\begin{matrix}\begin{matrix}\begin{matrix}\begin{matrix}\begin{matrix}Yaw rate \\ Velocity\end{matrix} \\ Sideslip\end{matrix} \\ Steering angle\end{matrix} \\ Rear wheelspeed\end{matrix} \\ Lateral error\end{matrix} \\ Course error\end{matrix} \\ Engine torque\end{matrix} \\ Front brake torque\end{matrix} \\ Rear brake torque\end{matrix} \\ Longitudinal weight transfer\end{matrix} ] . \qquad Equation ( 1 )$$

Here, steering angle, rear-wheel speed, engine torque, weight transfer, front brake torque, and rear brake torque are included as states for diversity. This example yields a total of eleven vehicle states. To encode constraints for an actuator slew-rate, four inputs may be used by the prediction model 260:

$$u = [ \begin{matrix}\dot{δ} \\ \dot{τ} \\ {\dot{τ}}_{brake , f} \\ {\dot{τ}}_{brake , r}\end{matrix} ] = [ \begin{matrix}\begin{matrix}\begin{matrix}Steering rate \\ Engine rate\end{matrix} \\ Front brake rate\end{matrix} \\ Rear brake rate\end{matrix} ] . \qquad Equation ( 2 )$$

Moreover, the state derivatives describing the model for the vehicle 100 can be expressed as:

$$\dot{x} = [ \begin{matrix}\begin{matrix}\begin{matrix}\begin{matrix}\begin{matrix}\begin{matrix}\begin{matrix}\begin{matrix}\begin{matrix}\begin{matrix}\frac{{aF}_{yf} cos ( δ ) + {aF}_{xf} sin ( δ ) - {bF}_{y r} + {τ}_{bb}}{{I}_{z}} \\ \frac{\begin{matrix}( - {F}_{y r} sin ( δ - β ) + {F}_{xf} cos ( δ - β ) + \\ ( {F}_{y r} + {F}_{gy} ) sin ( β ) + ( {F}_{xr} + {F}_{gx} ) cos ( β ) )\end{matrix}}{m}\end{matrix} \\ \frac{\begin{matrix}( {F}_{yf} cos ( δ - β ) + {F}_{xf} sin ( δ - β ) + \\ ( {F}_{y r} + {F}_{gy} ) cos ( β ) - ( {F}_{xr} - {F}_{gx} ) sin ( β ) )\end{matrix}}{mV} - r\end{matrix} \\ \dot{δ}\end{matrix} \\ \frac{{r}_{w} ( τ - {F}_{xr} {r}_{w} )}{{I}_{w}}\end{matrix} \\ V Δϕ\end{matrix} \\ \dot{ϕ} - {κ}_{ref} \frac{V cos ( Δ ϕ )}{1 - {κ}_{ref} e}\end{matrix} \\ \dot{τ}\end{matrix} \\ {\dot{τ}}_{brake , f}\end{matrix} \\ {\dot{τ}}_{brake , r}\end{matrix} \\ - k ( {dF}_{z} - \frac{{h}_{cg}}{a + b} {F}_{xnet} )\end{matrix} ] , \qquad Equation ( 3 )$$

where a and b are the distance from the center of gravity to the front and rear axles, respectively, h_{cg} is the center of gravity height. Furthermore, r_{w} is the tire radius, m the vehicle mass, and I_{z} and I_{w} the yaw moments of inertia for the vehicle 100 and lumped rear axle, respectively. The longitudinal and lateral forces are given as F_{xf,r} and F_{yf,r}, for the front and rear tires, respectively. Also, τ_{bb} is the moment created from the lateral brake balance, and F_{gx} and F_{gy} the gravitational forces in the longitudinal and lateral directions. The longitudinal weight transfer equation is further described below. Here, κ_{ref} is the reference curvature and

\dot{ϕ}=\dot{β}+\dot{r}, Equation (4)

is the rotation rate of the velocity vector associated with the vehicle 100.

In one approach, the prediction system 170 uses a tire model and road topology for optimizing control associated with the projected trajectory generated by an ADS at the handling limits 240. Here, the forces F_{xf,r} and F_{yf,r} are estimated by a coupled slip, Fiala brush tire model. For an unsaturated tire, this can be expressed as:

$$[ \begin{matrix}{F}_{y} \\ {F}_{x}\end{matrix} ] = ( {C}_{f} σ - \frac{{C}_{f}^{2} {σ}^{2}}{3 μ {F}_{z}} + \frac{{C}_{f}^{3} {σ}^{3}}{27 {( μ {F}_{z} )}^{2}} ) [ \begin{matrix}\frac{- tan ( α )}{σ} \\ \frac{κ}{σ}\end{matrix} ] . \qquad Equation ( 5 )$$

In Equation (5), C_{f} is the cornering stiffness, κ the slip ratio, α the slip angle, μ the coefficient of friction, and F_{z} the normal load. Furthermore, the combined slip σ is given as:

σ=\sqrt{tan(α)²+κ²}. Equation (6)

If saturated, resulting from the maximum slip, the forces can be expressed as:

$$[ \begin{matrix}{F}_{y} \\ {F}_{x}\end{matrix} ] = ( μ {F}_{z} ) [ \begin{matrix}- tan ( α ) / σ \\ κ / σ\end{matrix} ] , \qquad Equation ( 7 )$$

where saturation occurs if:

|σ|>arctan(3μF_{z}/C_{f}). Equation (8)

Regarding the road topology, conditions from topology can affect the normal load on the front and rear axle as follows:

$${F}_{z f} = \frac{b}{a + b} m ( g cos ( θ ) cos ( ψ ) + {A}_{v} ) . \qquad Equation ( 9 )$$

$${F}_{zr} = \frac{a}{a + b} m ( g cos ( θ ) cos ( ψ ) + {A}_{v} ) , \qquad Equation ( 10 )$$

where θ and ψ are the road grade and bank, respectively. The speed effect of vertical curvature can be expressed as:

$${A}_{v} = ( - \frac{d θ}{d s} cos ( ψ ) - K sin ( ψ ) cos ( θ ) ) {( \dot{s} )}^{2} . \qquad Equation ( 11 )$$

Here, K may represent the road curvature. In addition to the load transfer, topology also contributes forces in the longitudinal and lateral direction of the vehicle 100 for operating at the handling limits 240. This can be expressed respectively as:

F_{gy}=−mg cos(θ)sin(ψ), Equation (12)

F_{gx}=mg sin(θ). Equation (13)

As explained below, in one embodiment, the prediction system 170 generates vehicle dynamics using a load transfer and a brake distribution for the prediction model 260 according to estimated road conditions and the handling limits 240. Regarding the load transfer, the tire force may depend on the load at individual tires of the vehicle 100. The maximum force available can be the frictional force using a scaled friction circle. The prediction system 170 uses first-order dynamics for the longitudinal load transfer to identify available frictional forces. In one approach, the load transfer may be expressed as:

$$d {\dot{F}}_{z} = - k ( d {F}_{Z} - \frac{{h}_{c g}}{a + b} {F}_{xnet} ) , \qquad Equation ( 14 )$$

where k is a constant, dF_{z} the load transferred from the front to rear axle. Here, Fₓₙₑₜ can be expressed as:

Fₓₙₑₜ=Fₓᵣ+F_{xf} cos(δ)−F_{yf} sin(δ)+F_{gx}. Equation (15)

Hence, the load on the front and rear axles are given respectively as:

F_{zf}=F_{zf}−dF_{z}, Equation (16)

F_{zr}=F_{zr}+dF_{z}. Equation (17)

Correspondingly, the prediction system 170 can calibrate a transfer model for weight using pitch stiffness during constant acceleration and braking involving the vehicle 100. Transient pitch behavior, measured during step changes in acceleration and braking, is then processed by the prediction system 170 to estimate the parameter k from Eq. (14). In one approach, the parameter k=3.01 is selected such that simulations for the vehicle 100 use pitch that is realistic.

In various implementations, the prediction system 170 calculates a lateral brake balance below or separate from the processing layer of the NMPC using a static load transfer involving lateral motion. For the right and left side, this can be expressed respectively by:

r_{brake}=(g/2+a_{y}h_{cg}/t_{width})(g/2−a_{y}h_{cg}/t_{width}), Equation (18)

τ_{brake,r}=τ_{brake,f,r}r_{brake}/(1+r_{brake}), Equation (19)

τ_{brake,l}=τ_{brake,f,r}/(1+r_{brake}), Equation (20)

where g is the gravitational constant, t_{width} the vehicle track width, and a_{y} the lateral acceleration. This motion can create an additional moment of:

τ_{bb}=−r_{w}(τ_{brake,fl}−τ_{brake,fr})cos(δ)(t_{width}/2)−r_{w}(τ_{brake,rl}−τ_{brake,rr})(t_{width}/2), Equation (21)

where τ_{brake,f} and τ_{brake,r} are the front and rear brake torques, respectively.

As previously noted, the prediction system 170 can optimize gears and gear changes for an ADS to operate at the handling limits 240. In one approach, the gears and the gear changes are modeled outside the NMPC. For example, the NMPC requests a drive force from an engine controller associated with a driving command. The prediction system 170 may ensure that the vehicle drivetrain is in a state that delivers the drive force optimally by adapting gears. As such, target gears for individual points on the projected or reference trajectory are identified by a drivetrain controller. The vehicle tracks the target gear using a lower-level gear shifting controller running separately from the NMPC.

With the vehicle dynamics and gear changes modeled, the prediction system 170 may develop an NMPC through two optimal control problems (OCPs). The first one generates a reference trajectory which optimizes for a track length, and a fixed horizon MPC to be used online. The MPC may be given in general form as:

$$\begin{matrix}min J & \\ s . t . & {x}_{k + 1} = f ( x , u ) \\ & g ( x , u ) = 0 \\ & h ( x , u ) \leq 0 \\ & {x}_{min} \leq x \leq {x}_{max} \\ & {u}_{min} \leq u \leq {u}_{max} \\ & {x}_{0} = {x}_{i}\end{matrix} , \qquad Equation ( 22 )$$

with J being the cost, x the state vector, and u the input vector. xₘᵢₙ and xₘₐₓ may be the minimum and maximum values for the state vector, respectively. Also, uₘᵢₙ and uₘₐₓ may be defined similarly for certain inputs. Lastly, the initial state, x₀, can be constrained as equal to the current state measurement, xᵢ for modeling.

Regarding details of estimating the cost, the prediction system 170 can calculate cost online as:

J=J_{N}+Jₛ_{_{N}}+Σᵢ₌₀^{N}(Jₑ_{ᵢ}+Jₜ_{ᵢ}+J_{α}_{ᵢ}+Jₓ_{ᵢ}+J_{F}_{ᵢ}+J_{ü}_{ᵢ}+Jᵤ)·dsᵢ, Equation (23)

where N is the horizon length, J_{N} the terminal cost, and dsᵢ the step length of path distance. The running cost can have several terms penalizing the state, deviation from the reference trajectory, and control effort, weighted by the potentially different step lengths at individual steps. Furthermore, a state-bound cost can impose a penalty on the vehicle 100 for a track-bound violation and exceeding the maximum vehicle sideslip. The components of this cost can be active if the maximum or minimum values are exceeded. When exceeded, this cost may be given as:

Jₑ_{ᵢ}=w_{tb}(eᵢ−eₘᵢₙ_{ᵢ}_{,max}_{ᵢ})²+w_{β}(βᵢ−β_{min,max})², Equation (24)

where w_{tb} weighs track bound violations, and w_{β} is a weight on exceeding the sideslip range.

Moreover, a tracking cost penalizes the lateral error from the reference trajectory, as well as time. This can be given as:

Jₜ_{ᵢ}=wₑeᵢ²+wₜ(dsᵢ/\dot{s}ᵢ), Equation (25)

where wₑ is a weight on the lateral error and wₜ a weight on time. Also, the prediction system 170 can impose a small regularization cost on the front tire sideslip to avoid zero gradients at tire saturation. This can be given as:

J_{α}_{ᵢ}=w_{α}α_{f}_{ᵢ}², Equation (26)

with the weight w_{α} weighing the sideslip.

In one approach, a state regularization cost imposes a small cost penalizing deviation from the reference velocity and brake torques. This can be given as:

$${J}_{{x}_{i}} = {{w}_{V} ( {V}_{i} - {V}_{{ref}_{i}} )}^{2} + {{w}_{{τ}_{{brake}_{f}}} ( {τ}_{{brake}_{f , i}} - {τ}_{{brake}_{f , ref , i}} )}^{2} + , \qquad Equation ( 27 )$$

$${{w}_{{τ}_{{brake}_{r}}} ( {τ}_{{brake}_{r , i}} - {τ}_{{brake}_{r , ref , i}} )}^{2}$$

where w_{V} is the velocity weight, and

$${w}_{{τ}_{{brake}_{f}}} and {w}_{{τ}_{{brake}_{r}}}$$

the front and rear brake torque weights, respectively. Also, V_{ref} is the reference velocity, while τ_{brake}_{_{f,ref}} and τ_{brake}_{_{r,ref}} are the reference front and rear brake torques, respectively.

In one approach, the prediction system 170 may also factor rear axle input costs for adjusting the prediction model 260. Here, the rear axle input cost may penalize both the rear brakes and engine from being applied substantially simultaneously. This can be expressed as:

J_{u,r}=wᵣ(τ_{brake,r}τ)², Equation (28)

where wᵣ is the weight.

In FIG. 3, costs may penalize forces exceeding the friction circle 310 at the lumped front and rear tires, accounting for longitudinal load transfer. In this way, spinout, sideslip, understeering, oversteering, and so on may be prevented. When the force is exceeded, this can be given as:

$${J}_{{F}_{i}} = {{w}_{F} ( {( \frac{{F}_{x {f}_{i}}^{2} + {F}_{y {f}_{i}}^{2}}{{( {μ}_{f} {F}_{z {f}_{i}} )}^{2}} - {( {μ}_{lim} {F}_{z f} )}^{2} )}^{2} + ( \frac{{F}_{x {r}_{i}}^{2} + {F}_{y {r}_{i}}^{2}}{{( {μ}_{r} {{F}_{z r}}_{i} )}^{2}} ) - {( {μ}_{lim} {F}_{zr} )}^{2} )}^{2} , \qquad Equation ( 29 )$$

where w_{F} is a weight, μₗᵢₘ an imposed limit on friction utilization, and F_{z} the load on individual tires accounting for longitudinal load transfer and topology. Here, the prediction system 170 may factor the longitudinal load transfer and topology as they can impact the force potential at individual tires of the vehicle 100.

Additional costs are computed by the prediction system 170 to estimate vehicle dynamics. An input acceleration cost penalizes the engine torque and steering angle acceleration to promote smoother inputs. This can be given as:

J_{ü}_{ᵢ}=w_{\ddot{δ}}\ddot{δ}ᵢ²+w_{\ddot{τ}}\ddot{τ}ᵢ², Equation (30)

with w_{\ddot{δ}} and w_{\ddot{τ}} being the weights. An input cost applies a small regularization to the reference brake torque rate. This can be given as:

Jᵤ=w_{\dot{τ}}(\dot{τ}_{brake,r}−\dot{τ}_{brake,r,ref})²+w_{\dot{τ}}(\dot{τ}_{brake,f}−\dot{τ}_{brake,f,ref})², Equation (31)

where w_{\dot{τ}} is the weight. Furthermore, a terminal stability cost regulates sideslip and error stability. The cost can be shaped to encourage first-order dynamics for restoring path error and sideslip at the terminal state. This can be given as:

Jₛ_{_{N}}=w_{\dot{β}}_{_{N}}dsᵢ(\dot{β}_{N}+k_{\dot{β}}β_{N})²+w_{ė}ds_{N}(ė_{N}+k_{ė}e_{N})², Equation (32)

with w_{\dot{β}} being a weight on sideslip rate, and w_{ė} being a weight on the lateral error rate. Here, k_{\dot{β}} and k_{ė} are constants. Also, a terminal cost can be expressed as:

J_{N}=w_{e,N}e_{N}²+w_{Δϕ,N}Δϕ_{N}²+w_{V}(V_{N}−V_{ref,N})², Equation (33)

with the terminal weights being w_{e,N} for the lateral error, w_{Δϕ,N} on the course error, and W_{V} on the terminal velocity error.

In various implementations, the prediction system 170 generates vehicle dynamics using an initial state x₀, that is constrained to be equal with the most recent measurement, xₘₑₐₛ. This is can be expressed as:

x₀=xₘₑₐₛ. Equation (34)

The vehicle 100 may also have actuation constraints involving maximum and minimum bounds. Here, the bounds are imposed on the inputs and states to maintain consistency with the capabilities of the vehicle 100:

$$[ \begin{matrix}{δ}_{min} \\ {\dot{δ}}_{min} \\ {ω}_{r , min} \\ {τ}_{min} \\ {τ}_{brake , min} \\ {τ}_{brake , min} \\ {\dot{τ}}_{brake , min} \\ {\dot{τ}}_{brake , min}\end{matrix} ] \leq [ \begin{matrix}δ \\ \dot{δ} \\ {ω}_{r} \\ τ \\ {τ}_{brake , f} \\ {τ}_{brake , r} \\ {\dot{τ}}_{brake , f} \\ {\dot{τ}}_{brake , r}\end{matrix} ] \leq [ \begin{matrix}{δ}_{max} \\ {\dot{δ}}_{max} \\ {ω}_{r , max} \\ {τ}_{max} \\ {τ}_{brake , max} \\ {τ}_{brake , max} \\ {\dot{τ}}_{brake , max} \\ {\dot{τ}}_{brake , max}\end{matrix} ] . \qquad Equation ( 35 )$$

Furthermore, a slew constraint can bound the steering acceleration as:

\ddot{δ}ₘᵢₙ≤\ddot{δ}≤\ddot{δ}ₘₐₓ Equation (36)

As previously explained, the load on individual tires of the vehicle 100 will vary from load being transferred longitudinally between the front and rear axles and laterally during acceleration, cornering, and turns. For example, as the load is shifted forward during braking, the front tires have more capability to generate forces due to the increased load, and concomitantly, the rear tires have less. As such, the prediction system 170 can allocate a dynamic brake balance through brake torques among tires independently and leverage more capabilities of the vehicle 100, thereby increasing performance. In one approach, the NMPC allocates forces by treating longitudinal brake torque on the front and rear axle as separate states for improved computations. Also, when a static weight distribution of the vehicle 100 is biased to the front and load transfers forward during braking, the prediction system 170 can constrain the front brake torque at a larger magnitude than the rear brake torque. For instance, this constraint can be expressed as:

τ_{brake,r}>τ_{brake,f} Equation (37)

In one approach, the prediction system 170 uses Kalman filtering to estimate friction accurately and efficiently for non-linear modeling. For instance, the prediction system 170 implements a UKF using the bicycle model while accounting for longitudinal and lateral forces coupling, load transfer, road topology, and so on. The UKF may process the yaw rate, sideslip, velocity, front friction, and rear friction as limited states to simplify computations. Here, the UKF correction step can be based upon measurements of the yaw rate, velocity, and sideslip. Furthermore, the UKF runs at a particular frequency (e.g., 62.5 Hertz (Hz)) and the MPC bicycle model is updated with the current friction estimate accordingly.

Moreover, the prediction system 170 factors uncertainty by updating the μₗᵢₘ with the estimate μₗᵢₘ=μₙₒₘ−σ. Here, μₙₒₘ may represent a maximum friction utilization and σ an estimated standard deviation. The prediction system 170 may utilize the estimated uncertainty for both the front and rear tires such that when σ is elevated, the maximum allowable friction is reduced. As the estimate becomes certain and σ decreases, the friction utilization approaches μₙₒₘ. In this way, the MPC is conservative during uncertain periods in estimates and approaches increased friction availability as the UKF converges on improved estimates, thereby improving overall performance.

Regarding tuning, the prediction system 170 automatically tunes the UKF for the process noise covariance matrix and initial friction variance. The prediction system 170 can optimize the following function:

$$\begin{matrix}min J = {\sum }_{i = 0}^{N} {( {y}_{pred , i} - {y}_{m e a s , i} )}^{2} \\ s . t . {Q}_{min} \leq Q \leq {Q}_{max}\end{matrix} , \qquad Equation ( 38 )$$

where y_{pred} is the normalized predictions of the state vector consisting of yaw rate and velocity, and yₘₑₐₛ represents measurements. Also, Q is the process noise covariance matrix, and Qₘᵢₙ and Qₘₐₓ represent the upper and lower bounds, respectively. In one approach, the optimization iterations by the prediction system 170 may involve two steps. First, the UKF runs to obtain point-wise estimates of friction for the given process noise. Second, the prediction system 170 computes open-loop predictions, parameterized by the UKF estimates, over a complete data set. For example, the cost can involve six runs: two laps with a high initial estimation, two with a low initial estimate, and two with the nominal initial estimate. In this way, the cost function determines the process noise covariance that minimizes prediction error in an open loop compared to measurements.

Moreover, the prediction model 260 using MPC may adjust parameters using the UKF by leveraging adaptive friction estimates. In this way, the MPC can re-plan control inputs that are locally significant, particularly far from the reference trajectory. Operating away from the reference trajectory also allows the prediction system 170 to increasingly leverage the friction estimation from the UKF, since friction values can vary significantly from reference path conditions. Furthermore, the prediction system 170 increases performance using the Kalman filtering with dynamic lateral and longitudinal brake proportioning. Here, the commanded brake torque can be different for individual wheels of the vehicle 100, thereby accounting for lateral and longitudinal weight transfer. The prediction system 170 may also scale the friction circle 310 to increase allowable forces and braking range associated with an estimated path uncertainty for the projected trajectory. In this way, the vehicle 100 can brake aggressively without activation of anti-lock brake systems (ABS) and smoothly follow the projected trajectory.

Regarding more details on weight transfer, the prediction model 260 may model weight transfer to dynamically change brake balancing while braking the vehicle 100. In one approach, the target braking for the front and rear axle is dependent on the normal force at individual axles. Here, the longitudinal weight transfer during braking can have an increased impact on a target force for braking and brake balance. At the beginning of a flat braking zone, the weight distribution of the vehicle 100 can approximately equal the static weight distribution. Due to the dynamic load transfer, as the vehicle 100 brakes, more load can be transferred to the front axle that reduces the capability of generating force at the rear axle. In this example, the target brake balance shifts to bias the front axle and operating ranges and force utilization expands. For example, dynamic brake balance allows the NMPC to utilize the available rear braking force at the start of braking and also utilize the increased available braking force at the front axle as the load is transferred forward.

Regarding more details on the UKF and adjusting a MPC, the prediction system 170 increases the operating range of the NMPC by accounting for additional yaw moments while allocating brakes according to load transfer. In particular, this may increase the utilization of available friction force with saturation by modeling the friction variance along the projected trajectory at turns, corners, and so on. Furthermore, the prediction system 170 may converge to friction values through either lower or higher excitations by using a closed loop with NMPC and Kalman filtering. For example, the prediction system 170 identifies low excitations where tire forces are unsaturated, thereby improving vehicle control. Through this approach, the prediction system 170 may also detect smaller changes in the tire-road interaction and correct for modeling errors correlated with the coefficient of friction.

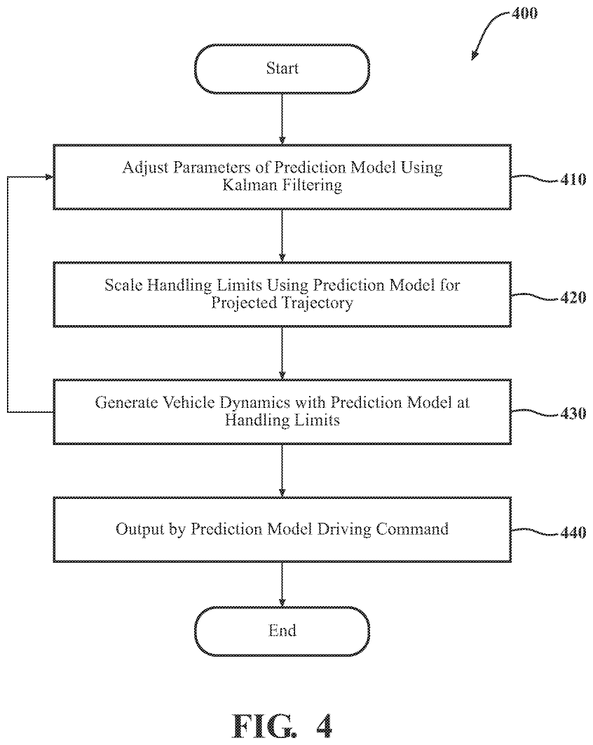

Turning now to FIG. 4, one embodiment of a method 400 that is associated with adjusting the prediction model 260 for controlling the vehicle 100 at the handling limits 240 using Kalman filtering and scaling is illustrated. The method 400 will be discussed from the perspective of the prediction system 170 of FIGS. 1 and 2. While the method 400 is discussed in combination with the prediction system 170, it should be appreciated that the method 400 is not limited to being implemented within the prediction system 170 but is instead one example of a system that may implement the method 400.

At 410, the prediction system 170 adjusts the parameters of a prediction model (e.g., NMPC) using Kalman filtering and friction estimates associated with a projected trajectory generated by an ADS. In one approach, the Kalman filtering iteratively uses covariance in states and friction, process noise (e.g., point-wise friction estimates), measurement noise, state measurements, open-loop prediction errors, and so on to estimate friction accurately. States may include a yaw rate, a velocity, a sideslip, estimated parameters for front-friction and rear-friction that the filtering processes until value convergence. Furthermore, as previously explained, the prediction system 170 may calculate and reduce various dynamic costs within the prediction model for increasing stability and comfort.

In one approach, the prediction system 170 factors estimate uncertainty by updating μₗᵢₘ with the estimate μₗᵢₘ=μₙₒₘ−σ associated with the Kalman filtering. Here, μₙₒₘ may represent a maximum friction utilization and σ an estimated standard deviation associated with an imposed limit for friction utilization involving the vehicle 100. The prediction system 170 may utilize the estimated uncertainty for both the front and rear tires such that when σ is elevated, the maximum allowable friction is reduced. As the estimate becomes more certain and σ decreases, the friction utilization approaches μₙₒₘ. In this way, the MPC is conservative during elevated uncertainty in the estimate and approaches increased friction utilization as the UKF converges on improved estimates.

At 420, the prediction system 170 scales the handling limits 240 using the prediction model for the projected trajectory. The handling limits 240 may define force saturation and available friction for individual tires of the vehicle 100. As such, a spinout, traction loss, and so on may occur if the vehicle 100 exceeds the handling limits 240. Furthermore, as previously explained, the prediction system 170 can adapt a friction circle for the projected trajectory, such as at the track edge, near an obstacle, and so on for increased force utilization. Here, the friction circle scales through expansion to increase the available force at individual tires within the handling limits 240, thereby maintaining control through a maneuver. The maximum force available may be the tire friction multiplied by the normal load at individual tires or an axle of the vehicle 100. Once a dangerous scenario is averted, the prediction system 170 may reduce the friction circle, thereby increasing comfort by reducing sudden movements or jerks.

Moreover, the prediction system 170 forms the friction circle using estimates from the Kalman filtering. In one approach, the friction circle incorporates errors and uncertainty from the friction estimates individually for front and rear tires of the vehicle 100 and factors load transfer. Furthermore, the prediction system 170 may adjust the coefficients of the prediction model online using the friction estimates for improving subsequent computations.

At 430, the prediction system 170 generates vehicle dynamics using the load transfer and brake distribution for the prediction model according to estimated road conditions and the handling limits 240. Here, the prediction system 170 may compute first-order dynamics for longitudinal load transfer such that available frictional forces at the handling limits 240 are utilized for braking. Correspondingly, the prediction system 170 can calibrate a weight transfer model using pitch stiffness during constant acceleration and braking involving the vehicle 100. As previously explained, the prediction model can use states (e.g., yaw vector) for axles of the vehicle 100 with the brake distribution separately. The load transfer may also bias braking the front tires while applying available braking on the rear tires at the handling limits 240 as load transfers forward during deceleration. Furthermore, the prediction system 170 may continue these calculations along points of the projected trajectory by further adjustments of the prediction model at 410. In this way, the prediction model adapts control at the handling limits 240 while utilizing available traction potential and tire friction that improves safety and comfort.

At 440, the prediction system 170 and the command module 220 use the prediction model to output a driving command for the projected trajectory. Here, the vehicle 100 can utilize the ADS and the prediction model to avoid an object by decelerating in a reduced distance at the handling limits 240 through the projected trajectory. As previously explained, the prediction system 170 may execute the prediction model at a layer separate from the chassis controls. In this way, the processing layer associated with the prediction model improves the accuracy of load transfer calculations by factoring grade measurements (e.g., road topology), gear-change modeling, and so on separate from chassis controls. As previously explained, the prediction system 170 using a separate (e.g., higher-level) processing layer can prioritize different attributes (e.g., minimum time, smoothness, comfort, etc.) while incorporating the non-linear dynamics for the vehicle 100 and model fidelity. As such, the prioritization improves determining vehicle limits given by friction and force limits at individual tires while avoiding saturating tires, oversteering, understeering, and so on.

Furthermore, the prediction system 170 extracts the potential and available friction for braking under various road conditions using the filtering and scaling of the friction circle. Such control and maneuvering avoids saturating tires on an individual basis. Accordingly, the prediction system 170 adjusts the prediction model for controlling a vehicle at handling limits that increase stability, traction, and stopping distances.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, Programmable Read-Only Memory (PROM), Erasable Programmable Read-Only Memory (EPROM), Electrically Erasable Programmable Read-Only Memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above or below ground level (e.g., potholes). The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the prediction system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140 and, thus, may be partially or fully autonomous as defined by the society of automotive engineers (SAE) levels 0 to 5.

The processor(s) 110, the prediction system 170, and/or the automated driving module(s) 160 can be operatively connected to communicate with the various vehicle systems 140 and/or individual components thereof. For example, returning to FIG. 1, the processor(s) 110, the prediction system 170, and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140.

The processor(s) 110, the prediction system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the prediction system 170, and/or the automated driving module(s) 160 can control the direction and/or speed of the vehicle 100. The processor(s) 110, the prediction system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the prediction system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or Flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system comprising:
a processor; and
a memory storing instructions that, when executed by the processor, cause the processor to:
adjust parameters of a prediction model using friction estimates and sideslip costs associated with a projected trajectory of a vehicle, the friction estimates being derived from Kalman filtering;
scale, using the prediction model, handling limits of the vehicle for the projected trajectory according to a friction circle;
generate, by the prediction model, vehicle dynamics using a load transfer and a brake distribution, the vehicle dynamics being associated with estimated road conditions and the handling limits; and
output, by the prediction model using the vehicle dynamics, a driving command to the vehicle for the projected trajectory.

2. The prediction system of claim 1, wherein the prediction model executes in a processing layer separate from controllers of a chassis and the prediction model implements a non-linear model predictive control (NMPC) that generates commands at the handling limits.

3. The prediction system of claim 1 further including instructions to:
estimate, by the Kalman filtering, the friction estimates for forming the friction circle that adapts to potential forces within the handling limits, wherein the friction circle incorporates errors and uncertainty from the friction estimates for front tires and rear tires of the vehicle and the load transfer; and
adapt coefficients of the parameters associated with the friction estimates.

4. The prediction system of claim 3, wherein the prediction model uses states for a front axle and a rear axle of the vehicle with the brake distribution separately and the load transfer biases braking to the front tires while applying available braking on the rear tires at the handling limits.

5. The prediction system of claim 3 further including instructions to:
tune the Kalman filtering iteratively using covariance in process noise, measurement noise, states, point-wise friction estimates for the process noise, and prediction errors, wherein the Kalman filtering implements an unscented Kalman filter (UKF) and the states include a yaw rate, a velocity, a sideslip, a front-friction value, and a rear-friction value.

6. The prediction system of claim 1, wherein the vehicle dynamics are first-order dynamics and the load transfer is a longitudinal load transfer caused by tire force available at different tires of the vehicle.

7. The prediction system of claim 1 further including instructions to:
request by the prediction model a drive force from an engine controller of the vehicle associated with the driving command;
identify a target gear using a drivetrain of the vehicle for the drive force; and
track by the vehicle the target gear using a lower-level gear controller operating separately from the prediction model.

8. The prediction system of claim 1, wherein the handling limits are associated with force saturation for coupled tires of the vehicle that the prediction model processes.

9. The prediction system of claim 1 further including instructions to:
compute the projected trajectory by an automated driving system (ADS) according to the handling limits and prior commands generated by the prediction model, wherein the vehicle utilizes the ADS and the prediction model to avoid an object by moving in a reduced distance at the handling limits using the projected trajectory.

10. A non-transitory computer-readable medium comprising:
instructions that when executed by a processor cause the processor to:
adjust parameters of a prediction model using friction estimates and sideslip costs associated with a projected trajectory of a vehicle, the friction estimates being derived from Kalman filtering;
scale, using the prediction model, handling limits of the vehicle for the projected trajectory according to a friction circle;
generate, by the prediction model, vehicle dynamics using a load transfer and a brake distribution, the vehicle dynamics being associated with estimated road conditions and the handling limits; and
output, by the prediction model using the vehicle dynamics, a driving command to the vehicle for the projected trajectory.

11. A method comprising:
adjusting parameters of a prediction model using friction estimates and sideslip costs associated with a projected trajectory of a vehicle, the friction estimates being derived from Kalman filtering;
scaling, using the prediction model, handling limits of the vehicle for the projected trajectory according to a friction circle;
generating, by the prediction model, vehicle dynamics using a load transfer and a brake distribution, the vehicle dynamics being associated with estimated road conditions and the handling limits; and
outputting, by the prediction model using the vehicle dynamics, a driving command to the vehicle for the projected trajectory.

12. The method of claim 11, wherein the prediction model executes in a processing layer separate from controllers of a chassis and the prediction model implements a non-linear model predictive control (NMPC) that generates commands at the handling limits.

13. The method of claim 11 further comprising:
estimating, by the Kalman filtering, the friction estimates for forming the friction circle that adapts to potential forces within the handling limits, wherein the friction circle incorporates errors and uncertainty from the friction estimates for front tires and rear tires of the vehicle and the load transfer; and
adapting coefficients of the parameters associated with the friction estimates.

14. The method of claim 13, wherein the prediction model uses states for a front axle and a rear axle of the vehicle with the brake distribution separately and the load transfer biases braking to the front tires while applying available braking on the rear tires at the handling limits.

15. The method of claim 13 further comprising:
tuning the Kalman filtering iteratively using covariance in process noise, measurement noise, states, point-wise friction estimates for the process noise, and prediction errors, wherein the Kalman filtering implements an unscented Kalman filter (UKF) and the states include a yaw rate, a velocity, a sideslip, a front-friction value, and a rear-friction value.

16. The method of claim 11, wherein the vehicle dynamics are first-order dynamics and the load transfer is a longitudinal load transfer caused by tire force available at different tires of the vehicle.

17. The method of claim 11 further comprising:
requesting by the prediction model a drive force from an engine controller of the vehicle associated with the driving command;
identifying a target gear using a drivetrain of the vehicle for the drive force; and
tracking by the vehicle the target gear using a lower-level gear controller operating separately from the prediction model.

18. The method of claim 11, wherein the handling limits are associated with force saturation for coupled tires of the vehicle that the prediction model processes.

19. The method of claim 11 further comprising:
computing the projected trajectory by an automated driving system (ADS) according to the handling limits and prior commands generated by the prediction model, wherein the vehicle utilizes the ADS and the prediction model to avoid an object by moving in a reduced distance at the handling limits using the projected trajectory.

20. The method of claim 11, wherein the sideslip costs are associated with restoring path error and sideslip at a terminal state for the vehicle dynamics at a first-order using the projected trajectory.
